(19) United States
(12) Patent Application Publication
(10) Pub. No.: US 2012/0301774 A1
(43) Pub. Date: Nov. 29, 2012

(54) INORGANIC/ORGANIC COMPOSITE POROUS SEPARATOR AND ELECTROCHEMICAL DEVICE USING THE SAME

(75) Inventors: De shun Jiang, Dongguan (CN); Yue Li Wang, Dongguan (CN); Wu Tang Zhang, Dongguan (CN); Jun Feng Jiao, Dongguan (CN)

(73) Assignee: Dongguan Amperex Technology Limited

(21) Appl. No.: 13/481,862

(22) Filed: May 27, 2012

(30) Foreign Application Priority Data
May 26, 2011 (CN) 201110138717.9

(51) Int. Cl. H01M 2/16; B05D 5/12; H01M 10/04

(52) U.S. Cl. 429/144; 429/251; 427/58

(57) ABSTRACT

Provided is an inorganic/organic composite porous separator including a porous substrate having pores and an active layer formed on the porous substrate. The active layer contains mixture of binder and inorganic particles. The inorganic/organic composite porous separator of the present invention has desirable anti-oxidation performance, and can prevent the separator from being oxidized in the lithium secondary battery using high voltage anode material. Also provided is a method for manufacturing the inorganic/organic composite porous separator and an electrochemical device using the same.

### CROSS-REFERENCE TO RELATED APPLICATION

The present patent application claims priority to Chinese patent application number CN 201110138717.9 flied on May 26, 2011, which application is incorporated herein by reference in its entirety and for all purposes.

### BACKGROUND OF THE INVENTION

1. Field of the Invention

The present invention generally relates to electrochemical devices and, more particularly, relates to a novel inorganic/organic composite porous separator, a method for manufacturing the inorganic/organic composite porous separator and an electrochemical device using the same.

2. Description of Related Art

At present, there is increasing interest in energy storage technology. Batteries have been widely used as energy sources in portable phones, camcorders, notebook computers, PCs and electric cars, resulting in intensive research and development for them. In this regard, electrochemical devices are the subject of great interest. Particularly, development of rechargeable secondary batteries is the focus of attention.

Secondary batteries are chemical batteries that can be charged and discharged repeatedly via the reversible interchange between chemical energy and electrical energy. Secondary batteries can be generally divided into Ni-MH secondary batteries and lithium secondary batteries. Lithium secondary batteries include lithium metal batteries, lithium ion secondary batteries, lithium polymer secondary batteries and lithium ion polymer secondary battery.

Lithium secondary batteries have been focus of attention in the field due to higher driving voltage and energy density relative to conventional batteries using aqueous solution as electrolyte, i.e. Ni-MH batteries. However, lithium secondary batteries have different safety characteristics depending on several factors. Evaluation of and security in safety of batteries are very important matters to be considered. Therefore, safety of batteries is strictly restricted in terms of safety performance and/or ignition and combustion of batteries by safety standards.

To prevent internal short circuit between the anode and the cathode, at present, lithium ion batteries and lithium ion polymer batteries generally use polyolefin separator as separator. However, the melting point of the polyolefin separator is no higher than 200° C. When the temperature in the battery rises due to external impacts or abuse, the polyolefin separator will shrink and/or melt, which may lead to short circuit between the anode and the cathode and further lead to safety accident, such as ignition or explosion of the battery. Therefore, it is necessary to provide a separator which does not shrink at high temperature.

To overcome the shortage of polyolefin separator as previously described, many attempts have been made to develop electrolyte which uses inorganic material to substitute conventional separator. The electrolyte can be generally divided into two types. At one aspect, inorganic particles which can conduct lithium ions are used to combine with porous substrate to obtain a composite separator. However, the composite separator has low ion conductivity, and interface resistance between the porous substrate and the inorganic particles is very high. At other aspect, inorganic particles which can conduct lithium ions are mixed with gel polymer electrolyte made from porous substrate and liquid electrolyte to obtain a composite separator. However, the content of the inorganic material introduced is much lower than the content of the polymer and the liquid electrolyte and, therefore, the inorganic material can only assist conducting the lithium ions generated from the liquid electrolyte to some extent.

As has been described, the conventional electrolyte which uses inorganic particles at least has the following disadvantages. First, if liquid electrolyte is not used, interface resistance between the inorganic particles and the porous substrate rises excessively, which will deteriorate performance of the battery. Second, when excessive inorganic material is introduced, treatment of the electrolyte is difficult to be carried out due to fragility of the inorganic material. The battery using this type of electrolyte is hard to be assembled. Particularly, most of the attempts have been made to develop composite electrolyte containing inorganic particles which can be used independently as separator. However, the electrolyte can hardly be used in the batteries due to poor mechanical property of the separator (such as high fragility). Even though the mechanical property can be improved via reducing the content of the inorganic particles, the mechanical property still will deteriorate due to the liquid electrolyte in the mixture of the inorganic particles and the liquid electrolyte, which will lead to failure in assembly of the battery. If the liquid electrolyte is injected after the battery was assembled, it will take a pretty long time for the electrolyte to disperse in the battery. Due to high content of polymer in the inorganic/organic composite separator, the actual wettability of the electrolyte is very poor. In addition, the inorganic particles added to improve safety performance will cause lithium ion conductivity reduce remarkably. Additionally, there is no pore in the electrolyte, or even though there is pore in the electrolyte, the size of the pore is only several angstroms and the porosity is very low. Therefore, the electrolyte cannot be used as separator.

What is needed, therefore, is to provide an inorganic/organic composite porous separator and an electrochemical device using the same which has desirable electrical performance and safety performance.

### SUMMARY OF THE INVENTION

It is one object of the present invention to provide an inorganic/organic composite porous separator and an electrochemical device using the same which has desirable electrical performance and safety performance.

According to one aspect of the present invention, an inorganic/organic composite porous separator is provided. The inorganic/organic composite porous separator includes a porous substrate having pores and an active layer formed on the porous substrate. The active layer contains mixture of inorganic particles and binder.

Preferably, the binder is coupling agent, or polyacrylic acid, or mixture of polyacrylic acid and polyacrylate, or mixture of coupling agent and polyacrylic acid, or mixture of coupling agent, polyacrylic acid and polyacrylate.

Preferably, the coupling agent is silane coupling agent having a decomposition temperature higher than 200° C., and the polyacrylate is sodium polyacrylate or potassium polyacrylate.

Preferably, the silane coupling agent is selected from a group consisting of water-based siloxane, epoxy silane, disamino silane, acyloxysilane, aryl silane and vinyl silane.

Preferably, molecular weight of the polyacrylic acid is 2000-10000000, and molecular weight of the polyacrylate is 2000-10000000.

Preferably, decomposition temperature of the polyacrylic acid is higher than 200° C.

Preferably, the particle size of the inorganic particle is 0.1-2 μm.

The inorganic/organic composite porous separator according to the present invention not only can act as the separator which can prevent the anode from contacting the cathode of the battery, but also can act as pathway of the lithium ions, so as to overcome the disadvantage of the poor thermal safety performance of the conventional polyolefin separator. The inorganic/organic composite porous separator according to the present invention has excellent lithium ion conductivity and desirable electrolyte wetting and absorbing ability.

The inorganic/organic composite porous separator according to the present invention is obtained via coating mixture of inorganic particles and polymer binder on the porous substrate. The pores in the substrate and interspaces between the inorganic particles form a uniform structure, which can enable the inorganic/organic composite porous separator to act as a desirable separator.

In the prior art, there is no pore structure in the conventional solid electrolyte formed by the inorganic particles and the polymer binder. Even though there is pore structure in the conventional solid electrolyte formed by the inorganic particles and the polymer binder, the pore only has an irregular pore structure having a size of several angstroms which does not allow the pass of the lithium ions, which will deteriorate the performance of the battery. On the contrary, the inorganic/organic composite porous separator according to the present invention has uniform pore structure in the porous substrate and the active layer. The uniform pore structure allows the lithium ions smoothly pass through the pore structure.

In the prior art, conventional separator or polymer electrolyte is formed as independent separator and further assembled together with the anode and cathode electrodes. On the contrary, the inorganic/organic composite porous separator according to the present invention is formed by directly coating the surface of the porous substrate having pores and, therefore, the pores in the porous substrate and the active layer can be fixed to provide stable physical bonding between the active layer and the porous substrate. Therefore, the inorganic/organic composite porous separator of the present invention has desirable mechanical property. In addition, the surface cohesive force between the porous substrate and the active layer can reduce interface resistance. The inorganic/organic composite porous separator of the present invention includes inorganic/organic composite porous layer formed on the porous substrate. In addition, the active layer does not affect the pore structure in the porous substrate, so as to maintain the pore structure. Moreover, the active layer itself also has uniform pore structure formed by the inorganic particles. The pore structures thereafter can be filled by the injected liquid electrolyte and, therefore, the interface resistance between the inorganic particles or the interface resistance between inorganic particles and the polymer binder can be reduced remarkably.

According to the test results, the inorganic/organic composite porous separator according to the present invention has desirable thermal safety performance due to the heat resistance property of the inorganic particles. The conventional polyolefin separator shrinks at high temperature because the melting point of the conventional polyolefin separator is about 120-140° C. or 150-170° C. The inorganic/organic composite porous separator according to the present invention will not shrink due to the heat resistance property of the inorganic particles. Safety performance of the electrochemical device which uses the inorganic/organic composite porous separator according to the present invention as separator is still desirable even in extreme conditions, such as used at high temperature or be overcharged. The electrochemical device according to the present invention has better safety characteristics than that of the conventional batteries.

It is well known in the art that, mixture of alumina and silica can be coated on PET to form non-woven fabric. However, this kind of composite fabric does not use polymer binder to support and interconnect inorganic particles. In addition, particle size and uniformity of the inorganic particle and the pore structure formed by the inorganic particles have not been recognized correctly. Therefore, the composite separator in the prior art may deteriorate the performance of the batteries. More particularly, when the inorganic particle has a large particle size, thickness of the active layer having same solid content will increase, which will deteriorate the mechanical performance of the separator. In addition, due to the large size of the pore, internal circuit short may occur during charge/discharge circle of the battery. In addition, there is no binder used for fixing, the final film may strip off from the substrate and, therefore, cannot be used in assembly of the battery. For instance, conventional composite film is not subject to laminate procedure. On the contrary, it is realized that, control of porosity and pore size of the inorganic/organic composite porous separator according to the present invention is a vital factor affecting the performance of the battery. Therefore, size of the inorganic particle can be optimized, so that the inorganic particles can be stably fixed in the polymer binder. Inorganic particles between the inorganic particles and the surface of the thermalstable porous substrate, or between the inorganic particles and the pores in the substrate, can improve the mechanical performance of the final inorganic/organic composite porous separator.

Because the binder in the inorganic/organic composite porous separator according to the present invention has desirable swelling, the electrolyte may penetrate into the binder after the battery is assembled. The penetrated electrolyte can conduct electrolyte ions. Therefore, compared with conventional inorganic/organic composite separator, the inorganic/organic composite porous separator according to the present invention can improve the performance of the electrochemical device. Compared with conventional hydrophilic polyolefin separator, wettability of the electrolyte is improved and use of polar electrolyte is allowed.

If the inorganic particles used in the active layer of the inorganic/organic composite porous separator according to the present invention has high dielectric constant and/or high lithium ion conductivity, the inorganic particles can improve lithium ion conductivity and heat resisting property and further improve the performance of the battery. In the inorganic/organic composite porous separator according to the present invention, the inorganic particle is preferably electronically insulative material has a dielectric constant no less than 5 and a coefficient of thermal conductivity less than 0.1 w/m·k.

In the inorganic/organic composite porous separator according to the present invention, there is no particular limitation in the substrate coated with mixture of inorganic particles and binder, as long as the substrate has pores. Non-limiting examples of the porous substrate can be used in the present invention include polyethylene substrate and polypropylene substrate, preferably having a thickness of 1-100 μm, and more preferably having a thickness of 10-20 μm. When the size of the pore is less than 0.01 μm and the porosity is less than 5%, the porous substrate may act as resistive layer. When the size of the pore is more than 50 μm and the porosity is more than 95%, the mechanical performance can hardly be maintained. According to an embodiment of the present invention, the porous substrate is PE film, PP film or PP/PE/PP composite micropore film having a porosity of 20-60% and a thickness of 5-50 μm.

In the inorganic/organic composite porous separator according to the present invention, one component present in the inorganic/organic composite porous separator coated on the surface of the porous substrate and/or part of the pores in the substrate is inorganic particles that are typically used in the art. Interspace between the inorganic particles may be formed, so as to form the micropores and maintain physical shape of the separator. In addition, physical characteristics of the inorganic particles do not change at 200° C. or even higher temperature. Therefore, the inorganic/organic composite porous separator having the inorganic particles according to the present invention has excellent heat resistance property.

In the inorganic/organic composite porous separator according to the present invention, one component of the active layer formed on the surface of the porous substrate or part of the pores is the binder that has not been used in the art so far. The binder is used to fix the inorganic particles and prevent the mechanical performance of the final inorganic/organic composite porous separator from being deteriorated.

When the binder has ion conductivity, it can further improve the performance of the electrochemical device. Therefore, the binder preferably has a dielectric constant as high as possible. In practice, because the dissociation degree of a salt in an electrolyte depends on the dielectric constant of the solvent used in the electrolyte, the binder having a higher dielectric constant can increase the dissociation degree of the salt in the electrolyte used in the present invention. The dielectric constant of the binder may range from 1.0 to 100 (as measured at a frequency of 1 kHz), and is preferably no less than 10. Non-limiting examples of the binder can be used in the present invention include water-based siloxane, γ-chloropropyltrimethoxysilane, vinyltrichlorosilane, vinyl tris(β-methoxyethoxy)silane, γ-(methoxyacryloyloxypropyltrimethoxysilane, vinyltrimethoxysilane, β-(3,4-epoxycyclohexyl)ethyltrimethoxysilane, γ-(2,3-epoxypropyl)propyltrimethylsilane, vinyltriethoxysilane, γ-mercaptopropyltrimethoxysilane, γ-aminopropyltriethoxysilane, γ-ureidopropyltriethoxysilane, 3-glycidoxypropyltrimethoxysilane, 3-glycidoxypropyltrimethoxysilane and other epoxy silane, disamino silane, 2-aminoethyl-3-aminopropyl-methyldimethoxysilane, 2-aminoethyl-3-aminopropyl-trimethoxysilane, 3-aminopropylmethyldiethoxysilane, 3-aminopropyltriethoxysilane, 3-aminopropyltrimethoxysilane, triamino-functional propyltrimethoxysilane, N-butyl-3-aminopropyltrimethoxysilane, acyloxysilane, di-t-butoxydiacetoxysilane, aryl silane, phenyltrimethoxysilane, phenyltriethoxysilane and vinyl silane. Other aqueous solution of polyacrylic acid having molecular weight of 2000-10000000 or mixture aqueous solution of the polyacrylic acid and sodium polyacrylate can also be used.

There is no particular limitation in materials for the inorganic particles as long as they are electrochemically stable and are not subjected to oxidation and/or reduction at the range of drive voltages (for example, 0-5V based on Li/Li+) of the battery to which they are applied. In particular, it is preferable to use inorganic particles having ion conductivity as high as possible, because such inorganic particles can improve the ion conductivity and performance of the electrochemical device. In addition, when inorganic particles having low heat conductivity are used, the inorganic particles can prevent the heat from dissipating to the surroundings and further inhibit ignition and/or explosion of the battery. Additionally, inorganic particles having high dielectric constant are desirable because they can contribute to an increase in the dissociation degree of the electrolyte salt in the liquid electrolyte, such as a lithium salt, to thereby improve the ion conductivity of the electrolyte. Non-limiting examples of the inorganic particles is an electronically insulative material selected from a group consisting of SiO₂, Al₂O₃, CaO, TiO₂, ZnO, MgO, ZrO₂ and SnO₂.

Additionally, the inorganic/organic composite porous separator according to the present invention may further include additives as the component of the active layer.

As described above, when the mixture of the inorganic particles and the binder is coated on the porous substrate, the inorganic/organic composite porous separator according to the present invention includes the pores in the porous substrate. Pore structure was also formed in the substrate and the active layer due to the interspace between the inorganic particles in the substrate. Size of the pore and porosity of the inorganic/organic composite porous separator mainly depend on the particle size of the inorganic particles. For instance, if inorganic particles having a particle size less than 1 μm are used, pore diameter of the pores formed will also be less than 1 μm. The previously described pore structure will be filled by electrolyte for conducting ion. Therefore, pore diameter and porosity are two main factors to control the ion conductivity of the inorganic/organic composite porous separator. Preferably, the pore diameter of the inorganic/organic composite porous separator according to the present invention is 0.01-10 μm. The porosity of the inorganic/organic composite porous separator according to the present invention is 5-95%.

There is no particular limitation in thickness of the inorganic/organic composite porous separator according to the present invention. The thickness of the inorganic/organic composite porous separator can be controlled according to the requirement of the battery performance. According to one embodiment of the present invention, the inorganic/organic composite porous separator preferably has a thickness of 1-100 μm, and more preferably 2-30 μm. The thickness of the inorganic/organic composite porous separator can be controlled to improve the battery performance.

There is no particular limitation in mixture ratio of the inorganic particles and the binder in the inorganic/organic composite porous separator according to the present invention. The mixture ratio of the inorganic particles and the binder can be properly adjusted according to the requirement of thickness and structure of the inorganic/organic composite porous separator.

The inorganic/organic composite porous separator of the present invention can be used in batteries together with other micro porous film (such as polyolefin film), depending on the characteristics of the final battery.

Summarizing the above, the present invention can overcome the shortage of undesirable thermal safety performance of the conventional polyolefin separator via forming inorganic/organic composite porous separator with the mixture of the porous substrate, the inorganic particles and the binder. The inorganic/organic composite porous separator of the present invention has desirable anti-oxidation performance, and can prevent the separator from being oxidized in the lithium secondary battery using high voltage anode material. The inorganic/organic composite porous separator of the present invention has more desirable absorbing and wetting ability for the electrolyte than that of the conventional polyolefin separator, can solve the absorption and immersion problem for the electrolyte in the lithium second battery, and avoid occurrence of lithium precipitation in the battery. In view of the foregoing, the inorganic/organic composite porous separator according to the present invention can remarkably improve the property and the safety performance of the electrochemical device which uses the inorganic/organic composite porous separator as the separator.

According to other aspect, the present invention also provides a method for manufacturing an inorganic/organic composite porous separator. The method includes the steps of: a) dissolving binder in solvent to make a solution; b) adding inorganic particles in the solution of step a) and dispersing to make an even mixture, wherein the mixture contains 60-85 wt % of inorganic particles; and c) coating the mixture of step b) on the surface of a porous substrate or part of the pores in the porous substrate and drying, so as to obtain inorganic/organic composite porous separator.

Preferably, concentration of the solution is 1-99 wt %. PH value of the solution is 4.0-6.0.

Preferably, concentration of the solution is 20-40 wt %. PH value of the solution is 4.0-4.5.

Hereafter, method for manufacturing the inorganic/organic composite porous separator according to the present invention will be explained in further detail.

In step a), the solvent used preferably has similar solubility and boiling point as that of the binder used. The solvent can be fully mixed with the binder and can be easily removed after being coated on the porous substrate. No-limiting examples of the solvent can be used includes water, N-methyl-2-pyrrolidone, cyclohexanone or mixture thereof.

In step b), the inorganic particles are preferably grinded before being added to the binder solution. The time for grinding the inorganic particles is preferably 1 to 20 hours. The particle size of the grinded inorganic particles is preferably 0.1 to 2 μm. Conventional method, preferably high energy ball milling method, can be used to grind the inorganic particles. Although there is no particular limitation in the composition of the mixture containing the inorganic particles and the binder solution, the composition contributes to the control of thickness of the final inorganic/organic composite porous separator, pore diameter of the pore and porosity.

In step c), any conventional method known to one skilled in the art can be used to coat the mixture of the inorganic particles and the binder on the porous substrate, including dip coating, die coating, roller coating, comma coating or combination thereof. In addition, mixture of the inorganic particles and the binder can be coated on one surface or two surfaces of the porous substrate.

It should be noticed that, the inorganic/organic composite porous separator can also be manufactured via other conventional methods known to one skilled in the art.

Additionally, according to a further aspect, the present invention provides an electrochemical device including an anode, a cathode, a separator interposed between the anode and the cathode and electrolyte. The separator is the inorganic/organic composite porous separator according to the present invention.

Electrochemical device may include any device that can carry out electrochemical reaction. Non-limiting examples of the electrochemical device include primary battery, secondary battery, fuel cell, solar battery or capacitor. Preferably, the electrochemical device is a lithium secondary battery, including lithium metal secondary battery, lithium ion secondary battery, polymer lithium secondary battery or polymer lithium ion secondary battery.

According to the present invention, the inorganic/organic composite porous separator in the electrochemical device still can be used together with other micro separator, such as polyolefin separator.

The electrochemical device may be manufactured by any conventional method known to one skilled in the art. In one embodiment of the method for manufacturing the electrochemical device, the electrochemical device is provided by forming an electrode assembly from the inorganic/organic composite porous separator interposed between a cathode and an anode, and then by injecting an electrolyte into the assembly.

The electrode used together with the inorganic/organic composite porous separator can be manufactured via coating electrode active material on current collector according to conventional methods known to one skilled in the art. Specifically, the anode active material includes any conventional anode active material used in the anode electrode of an electrochemical device. Non-limiting examples of anode active material include lithium insertion material, such as lithium manganese oxide, lithium cobalt oxide, lithium nickel oxide, lithium ferrite oxide or composite oxide thereof. In addition, the cathode active material includes any conventional cathode active material used in the cathode electrode of an electrochemical device. Non-limiting examples of cathode active material include lithium insertion material, such as lithium, lithium alloy, carbon, petroleum coke, active carbon, graphite or carbonaceous material. Non-limiting examples of anode current collector include aluminum foil, nickel foil and combination thereof. Non-limiting examples of cathode current collector include cupper foil, gold foil, nickel foil, cupper alloy foil or combination thereof.

The electrolyte which can be used in the electrochemical device of the present invention includes salt represented by formula A⁺B⁻, wherein A⁺ is selected from a group consisting of alkaline metal cation Li⁺, Na⁺ and K⁺, B⁻ is selected from a group consisting of anion PF₆⁻, BF₄⁻, Cl⁻, Br⁻, I⁻, ClO₄⁻, ASF₆⁻, CH₃CO₂⁻, CF₃SO₃⁻, N(CF₃SO₂)₂⁻, C(CF₂SO₂)₃⁻ and other salts which can dissolve or dissociate in the organic solvent, wherein the organic solvent is selected from a group consisting of propylene carbonate (PC), ethylene carbonate (EC), diethyl carbonate (DEC), dimethyl carbonate (DMC), dipropyl carbonate (DPC), dimethyl sulfoxide, acetonitrile, N-methyl-2-pyrrolidone (NMP), dimethoxyethane, tetrahydrofuran, γ-butyrolactone and ethyl methylcarbonate (EMC). However, the electrolyte that can be used in the present invention is not limited to the examples as listed above.

More specifically, according to the manufacturing method and the requirement of the product property, during the manufacturing of the electrochemical device, the electrolyte can be injected in suitable step. In other words, the electrolyte can be injected prior to the assembly of the electrochemical device or in the final step in assembly of the electrochemical device.

Methods for assembling the inorganic/organic composite porous separator in the battery include winding the separator and electrodes, stacking the separator and electrodes, as well as folding the separator and electrodes.

When the inorganic/organic composite porous separator according to the present invention is subject to stacking method, thermal safety of the battery can be improved remarkably, because compared with battery obtained via winding method, the separator of the battery obtained via stacking and folding may shrink more seriously. In addition, when stacking method is used, the battery can be assembled more easily due to the desirable adhesivity of the polymer in the organic/inorganic composite porous separator of the present invention. In this regard, the adhesivity can be controlled via adjusting the content of the inorganic particles and the content and property of the polymer. More particularly, when the polarity of the polymer increases and when the glass transition temperature (Tg) or melting point (Tm) of the polymer decreases, more desirable adhesivity between the inorganic/organic composite porous separator and the electrode can be obtained.

The foregoing and other objects, features and advantages of the present invention will become more apparent from the following detailed description when taken in conjunction with the accompanying drawings in which:

### BRIEF DESCRIPTION OF THE DRAWINGS

FIG. 1 is a cross-sectional schematic view of an inorganic/organic composite porous separator according to the present invention;

FIG. 2 is a photograph taken by a Scanning Electron Microscope (SEM) of a conventional PE separator;

FIG. 3 is a photograph taken by a Scanning Electron Microscope (SEM) of an inorganic/organic composite porous separator according to the present invention;

FIG. 4 is a C-rate characteristic diagram of a lithium secondary battery using the inorganic/organic composite porous separator according to the present invention and a C-rate characteristic diagram of a lithium secondary battery using conventional polythene separator; and

FIG. 5 is a circle characteristic diagram of a lithium secondary battery using the inorganic/organic composite porous separator according to the present invention and a circle characteristic diagram of a lithium secondary battery using conventional polythene separator.

### DETAILED DESCRIPTION OF THE INVENTION

Referring to FIG. 1, the inorganic/organic composite porous separator in accordance with one embodiment of the present invention includes a porous substrate 102 having pores (not shown) and an active layer formed on the porous substrate 102, the active layer containing the mixture of inorganic particles 104 and the binder 106, wherein the binder 106 is coupling agent, polyacrylic acid, or mixture of polyacrylic acid and polyacrylate, or mixture of coupling agent and polyacrylic acid, or mixture of coupling agent, polyacrylic acid and polyacrylate.

Reference will now be made in detail to the preferred embodiments of the present invention. It is to be understood that the following examples are illustrative only and the present invention is not limited thereto.

### EXAMPLES

### Example 1

### 1-1. Preparation of Inorganic/Organic Composite Porous Separator (Al₂O₃/PAA-PAAS)

50 wt % of Al₂O₃ powder was added to distilled water and stirred for an hour to make a solution. A solution containing 5% by solid weight of polyacrylic acid-sodium polyacrylate (PAA-PAAS) was added to the prepared solution containing 50 wt % Al₂O₃ and stirred for an hour to make a mixture. The mixture was grinded in a ball grinder for an hour. Solution containing 0.5% by solid weight of CMC was added to the grinded mixture and fully stirred for an hour to make slurry. The slurry was coated on one side of a polythene micropore membrane having porosity of 45% and thickness of 20 μm via coating machine. The thickness of the coating layer is 5 μm. The slurry then was evenly coated on the other side of the polythene micropore membrane. The thickness of the coating layer is 5 μm, so as to obtain a composite porous separator having a total thickness of 30 μm. Test the prepared composite porous separator with a mercury intrusion porosimeter. According to the test results, the prepared composite porous separator has a porosity of 45%, almost the same as that of the polythene micropore membrane.

### 1-2. Manufacture of Lithium Secondary Battery

Manufacture of Anode: To N-methyl-2-pyrrolidone (NMP) as solvent, 94.0 wt % of LiMnO₂ as anode active material, 4.0 wt % of carbon black as conductive agent and 2.0 wt % of polyvinylidene fluoride (PVDF) as binder were added to form mixed slurry for an anode. The slurry for an anode was evenly coated on Al foil having a thickness of 16 μm as anode collector and dried to form an anode. Then, the anode was subjected to roll press.

Manufacture of Cathode: To distilled water as a solvent, 94.5 wt % of graphite powder as cathode active material, 2.0 wt % of carbon black as conductive agent, 1.5 wt % of sodium carboxymethylcellulose (CMC) as thickening agent and 2.0 wt % of styrene butadiene rubber (SBR) as binder were added to form slurry for a cathode. The slurry was evenly coated on Cu foil having a thickness of 9 μm as cathode collector and dried to form a cathode. Then, the cathode was subjected to roll press.

Manufacture of Battery: The cathode and anode obtained as described above were stacked with the inorganic/organic composite porous separator obtained as described in Example 1 to form an assembly. Then, an electrolyte (dimethyl cabonate containing 1 M of lithium hexafluorophosphate (LiPF₆)) was injected thereto to provide a lithium secondary battery.

### Example 2

### 2-1. Preparation of Inorganic/Organic Composite Porous Separator (Al₂O₃/PAA-PAAS/CR)

50 wt % of Al₂O₃ powder was added to distilled water and stirred for an hour to make a solution. A solution containing 5% by solid weight of polyacrylic acid-sodium polyacrylate and 3% by solid weight of water-based silane coupling agent (3-glycidoxypropyltrimethoxysilane) was added and stirred for an hour to make a mixture. The mixture was grinded in the ball grinder for an hour. Solution containing 1.0% by solid weight of CMC was added to the grinded mixture and stirred for an hour to make slurry. After the polypropylene micropore film was treated via corona treatment or other surface treatment methods which can improve surface tension of the film, the slurry was evenly coated on one side of a polythene porous membrane having a porosity of 45% and a thickness of 20 μm via a coating machine. The thickness of the coating layer is 5 μm. The slurry was evenly coated on the other side of the polythene microporous membrane. The thickness of the coating layer is also 5 μm, to obtain a composite porous separator having a total thickness of 30 μm. Test the prepared composite porous separator with a mercury intrusion porosimeter. According to the test results, the prepared composite porous separator has a porosity of 40%.

### 2.2 Manufacture of Lithium Secondary Battery

Example 1 was repeated to provide a lithium secondary battery, except that inorganic/organic composite porous separator as described above in example 2 was used to manufacture the lithium secondary battery.

### Example 3

### 3-1. Preparation of Inorganic/Organic Composite Porous Separator (SiO₂/Al₂O₃/PAA-PAAS/CR)

40 wt % of Al₂O₃ powder and 10 wt % of SiO₂ powder was added to distilled water and stirred for an hour to make a solution. A solution containing 5% by solid weight of polyacrylic acid-sodium polyacrylate and 3% by solid weight of silane coupling agent (3-glycidoxypropyltrimethoxysilane) was added to the prepared solution and stirred for an hour to make a mixture. The mixture was grinded in a ball grinder for an hour. Solution containing 0.5% by solid weight of CMC was added to the grinded mixture and stirred for an hour to make slurry. After the polypropylene micropore film was treated via corona treatment or other surface treatment methods which can improve surface tension of the film, the slurry was evenly coated on one side of a polythene porous membrane having porosity of 45% and thickness of 20 μm via a coating machine. The thickness of the coating layer is 5 μm. The slurry was evenly coated on the other side of the polythene microporous membrane, to obtain a composite porous separator having a total thickness of 30 μm. Test the prepared composite porous separator with a mercury intrusion porosimeter. According to the test results, the prepared composite porous separator has a porosity of 40%.

### 3-2 Manufacture of Lithium Secondary Battery

Example 1 was repeated to provide a lithium secondary battery, except that inorganic/organic composite porous separator as described above in example 3 was used to manufacture the lithium secondary battery.

### Example 4

### 4-1. Preparation of Inorganic/Organic Composite Porous Separator (Al₂O₃/PAA-PAAS)

30 wt % of Al₂O₃ powder was added to distilled water and stirred for an hour to make a solution. A solution containing 5% by solid weight of polyacrylic acid-sodium polyacrylate was added to the prepared solution and stirred for an hour to make a mixture. The mixture was grinded in a ball grinder for an hour. Solution containing 0.5% by solid weight of CMC was added to the grinded mixture and stirred for an hour to make slurry. The slurry was evenly coated on one side of a polythene porous membrane having a porosity of 45% and a thickness of 20 μm via a coating machine. The thickness of the coating layer is 2 μm. The slurry was evenly coated on the other side of the polythene microporous membrane. The thickness of the coating layer is also 2 μm, so as to obtain a composite porous separator having a thickness of 24 μm. Test the prepared composite porous separator with a mercury intrusion porosimeter. According to the test results, the prepared composite porous separator has a porosity of 45%, almost the same as that of the polythene micropore membrane.

### 4-2. Manufacture of Lithium Secondary Battery

Example 1 was repeated to provide a lithium secondary battery, except that inorganic/organic composite porous membrane as described above in example 4 was used to manufacture the lithium secondary battery.

### Comparative Examples 1 and 2

### Comparative Example 1

Example 1 was repeated to provide a lithium secondary battery, except that a conventional PE film in the art was used. In Comparative Example 1, the porosity of the conventional PE film is 45%.

### Comparative Example 2

Example 1 was repeated to provide a lithium secondary battery, except that a conventional PP/PE/PP film in the art was used. In Comparative Example 2, the porosity of the conventional PP/PE/PP film is 40%.

### Property Analysis of Inorganic/Organic Composite Porous Separator

The following experiments were performed to analyze the surface of the inorganic/organic composite porous separator obtained according to the present invention and the properties thereof.

### Experiment 1: Surface Analysis of Inorganic/Organic Composite Porous Separator

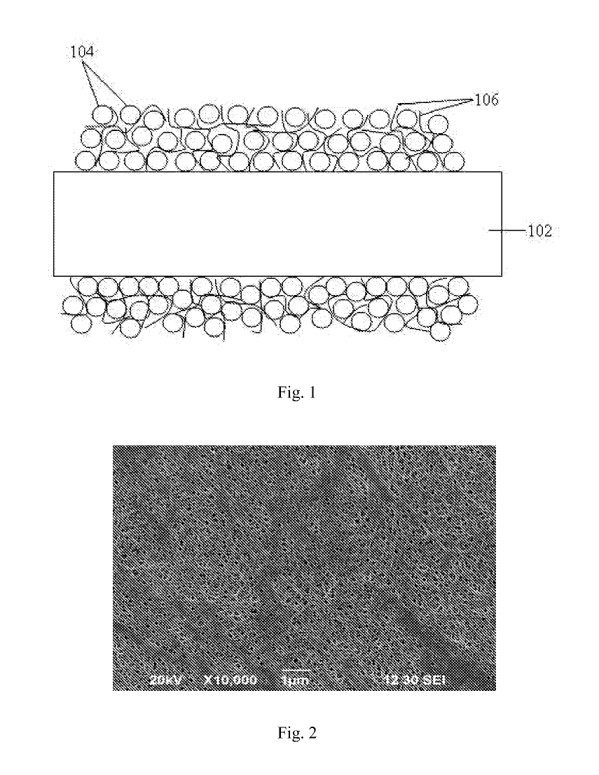

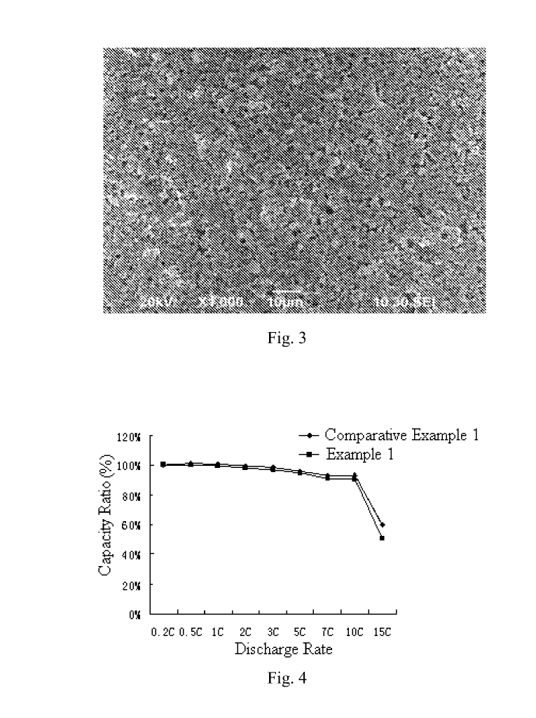

The sample used in this experiment was the Al₂O₃/PAA-PAAS composite porous separator according to Example 1. The PE separator in Comparative Example 1 was used as comparison. When analyzed by using Scanning Electron Microscope (SEM), the PE separator in Comparative Example 1 showed an ordinary pore structure as shown in FIG. 2. The inorganic/organic composite porous separator in Example 1 according to the present invention showed a continuous and compact pore structure formed between the inorganic particles coated on the porous substrate, as shown in FIG. 3.

### Experiment 2: Thermal Shrinkage of Inorganic/Organic Composite Porous Separator

The sample used in this experiment was the Al₂O₃/PAA-PAAS composite porous separator according to Example 1. The PE separator in Comparative Example 1 was used as comparison. The sample of Example 1 and the sample in Comparative Example 1 were stored at 200° C. for five minutes. The thermal shrinkage rate of each sample was examined Test result shows that the PE separator in Comparative Example 1 contracted and curved due to the high temperature, the PE separator becomes transparent and the micro pore structure amalgamated. In comparison, the thermal shrinkage of the inorganic/organic composite porous separator in Example 1 of the present invention is very slight. There is no remarkable amalgamation of the micro pore structure of the inorganic/organic composite porous separator. The inorganic/organic composite porous separator according to the present invention has desirable thermal stability.

### Experiment 3: Evaluation of Safety Performance of Lithium Secondary Battery

### Experiment 3-1

Nail Test: The samples of lithium secondary battery according to Examples 1 to 4 and the samples of lithium secondary battery according to Comparative Example 1 to 2 were overcharged to 4.2V, respectively. The voltage and the resistance were tested after the samples were kept still for an hour. Iron nail having a diameter of 5 mm was used to penetrate each sample for monitoring the surface temperatures and observing the performance of each battery. According to test results, the lithium secondary batteries of Examples 1 to 4 did not smoke, ignite or explode, indicating that the lithium secondary batteries have desirable safety performance. However, the lithium secondary batteries of Comparative Examples 1 to 2 smoked and ignited. Therefore, the lithium secondary battery using the inorganic/organic composite porous separator according to the present invention has desirable safety performance and can prevent the battery from igniting and exploding.

### Experiment 3-2

Overcharge Test: The samples of lithium secondary battery in Examples 1 to 4 and the samples of lithium secondary battery in Comparative Examples 1 to 2 were discharged to 3.0V, respectively, and then were overcharged to 6.0V with 1 C current and kept at 6.0V for 2.5 hours. The samples of lithium secondary batteries in Examples 1 to 4 did not smoke or ignite or explode, while the samples of the lithium secondary batteries in Comparative Examples 1 and 2 smoked and ignited. According to the test results, the lithium secondary battery using the inorganic/organic composite porous separator of the present invention has desirable anti-overcharge safety performance.

### Experiment 3-3

Hot oven test: The samples of lithium secondary batteries in Examples 1 to 4 and the samples of lithium secondary batteries in Comparative Example 1 and 2 were overcharged to 4.2V and kept still for an hour, respectively. The samples then were put in the hot oven at 150° C. for an hour. The samples of lithium secondary batteries in Examples 1 to 4 did not smoke or ignite or explode, while the samples of the lithium secondary batteries in Comparative Example 1 and 2 smoked and ignited. According to the test results, the lithium secondary batteries using the inorganic/organic composite porous separator of the present invention can prevent the lithium secondary battery from igniting and burning.

### Experiment 3-4

Impact test: The samples of lithium secondary batteries in Examples 1 to 4 and the samples of lithium secondary batteries in Comparative Example 1 to 2 were overcharged to 4.2V. A rod having a diameter of 15.8 mm and a weight of 9.1 Kg was used to impact the central portion of the batteries from 61 cm high over the battery. The samples of lithium secondary battery in Examples 1 to 4 did not smoke or ignite or explode, while the samples of the lithium secondary batteries in Comparative Examples 1 and 2 smoked and ignited. According to the test results, the lithium secondary battery using the inorganic/organic composite porous separator of the present invention can prevent the lithium secondary battery from igniting and burning.

### Experiment 3-5

Squeeze Test: The samples of lithium secondary battery in Examples 1 to 4 and the samples of lithium secondary battery in Comparative Examples 1 to 2 were overcharged to 4.2V. The samples then were sandwiched between two planar plates and were squeezed until the pressure arrived at 13 KN. The pressure then was released. The samples of lithium secondary battery in Examples 1 to 4 did not smoke or ignite or explode, while the samples of the lithium secondary battery in Comparative Examples 1 and 2 smoked and ignited. According to the test results, the lithium secondary battery using the inorganic/organic composite porous separator of the present invention can prevent the lithium secondary battery from igniting and burning.

### Experiment 4: Evaluation of Performance of Lithium Secondary Battery

### Experiment 4-1

Evaluation of C-rate characteristics: Lithium secondary battery according to Example 1 was used as sample. As comparison, used was the lithium secondary battery according to Comparative Example 1. Referring to FIG. 4, according to the test results, the lithium secondary battery using the inorganic/organic composite porous separator of the present invention almost has the same C-rate characteristics as that of the lithium secondary battery using the conventional polyolefin-based separator of Comparative Example 1.

### Experiment 4-2

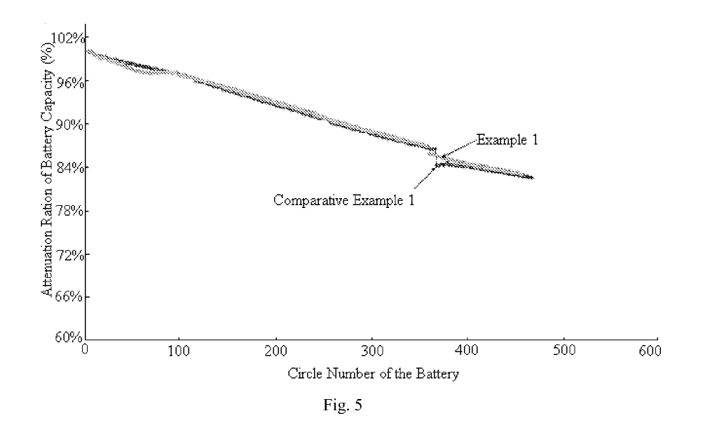

Evaluation of Circle Performance: Lithium secondary battery according to Example 1 was used as sample. As comparison, used was the lithium secondary battery according to Comparative Example 1. Referring to FIG. 5, according to the test results, the lithium secondary battery using the inorganic/organic composite porous separator of the present invention almost has the same circle characteristics as that of the lithium secondary battery using the conventional polyolefin-based separator.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

What is claimed is:

1. An inorganic/organic composite porous separator, comprising:
a porous substrate having pores; and
an active layer formed on the porous substrate, the active layer comprising mixture of binder and inorganic particles.

2. The inorganic/organic composite porous separator of claim 1, wherein the binder is coupling agent, or polyacrylic acid, or mixture of polyacrylic acid and polyacrylate, or mixture of coupling agent and polyacrylic acid, or mixture of coupling agent, polyacrylic acid and polyacrylate.

3. The inorganic/organic composite porous separator of claim 2, wherein the coupling agent is silane coupling agent having a decomposition temperature higher than 200° C., and the polyacrylate is sodium polyacrylate or potassium polyacrylate.

4. The inorganic/organic composite porous separator of claim 3, wherein the silane coupling agent is selected from a group consisting of water-based siloxane, epoxy silane, disamino silane, acyloxysilane, aryl silane and vinyl silane.

5. The inorganic/organic composite porous separator of claim 2, wherein molecular weight of the polyacrylic acid is 2000-10000000, molecular weight of the polyacrylate is 2000-10000000, and decomposition temperature of the polyacrylic acid or polyacrylate is higher than 200° C.

6. The inorganic/organic composite porous separator of claim 1, wherein diameter of pore in the inorganic/organic composite porous separator is 0.01-10 μm, porosity of the inorganic/organic composite porous separator is 5-95%.

7. The inorganic/organic composite porous separator of claim 1, wherein the inorganic particle is electronically insulative material having dielectric constant no less than 5 and heat conductivity less than 0.1 w/m·k.

8. The inorganic/organic composite porous separator of claim 7, wherein the electronically insulative material is selected from a group consisting of SiO₂, Al₂O₃, CaO, TiO₂, ZnO, MgO, ZrO₂ and SnO₂.

9. The inorganic/organic composite porous separator of claim 1, wherein the inorganic particle has a particle size of 0.1-2 μm.

10. The inorganic/organic composite porous separator of claim 1, wherein the porous substrate is PE membrane, PP membrane or PP/PE/PP composite microporous membrane having a porosity of 20-60% and a thickness of 5-50 μm.

11. A method for manufacturing the inorganic/organic composite porous separator of claim 1, comprising the steps of:
a) dissolving binder in solvent to make a solution;
b) adding inorganic particles into the solution in step a) and fully mixing to make a mixture, wherein the content of the inorganic particles in the mixture is 60-85 wt %; and
c) evenly coating the mixture in step b) on the surface of a porous substrate or part of the pores in the porous substrate and drying, so as to obtain an inorganic/organic composite porous separator.

12. The method of claim 11, wherein concentration of the solution is 1˜99 wt %, and PH value of the solution is 4.0-6.0.

13. The method of claim 11, wherein concentration of the solution is 20-40 wt %, and PH value of the solution is 4.0-4.5.

14. An electrochemical device, comprising: anode, cathode, separator disposed between the anode and the cathode, and electrolyte, wherein the separator is the inorganic/organic composite porous separator of claim 1.
